(19) United States
(12) Patent Application Publication
(10) Pub. No.: US 2013/0022274 A1
(43) Pub. Date: Jan. 24, 2013

(54) SPECIFYING VALUES BY OCCLUDING A PATTERN ON A TARGET

(71) Applicants: Roy Lawrence Ashok Inigo, San Diego, CA (US); Michael Gervautz, Vienna (AT)

(72) Inventors: Roy Lawrence Ashok Inigo, San Diego, CA (US); Michael Gervautz, Vienna (AT)

(73) Assignee: QUALCOMM INCORPORATED, San Diego, CA (US)

(21) Appl. No.: 13/343,263

(22) Filed: Jan. 4, 2012

Related U.S. Application Data
(60) Provisional application No. 61/511,002, filed on Jul. 22, 2011.

(51) Int. Cl. G06K 9/46

(52) U.S. Cl. 382/195

(57) ABSTRACT

A mobile platform captures a scene that includes a real world object, wherein the real world object has a non-uniform pattern in a predetermined region. The mobile platform determines an area in an image of the real world object in the scene corresponding to the predetermined region. The mobile platform compares intensity differences between pairs of pixels in the area, with known intensity differences between pairs of pixels in the non-uniform pattern, to identify any portion of the area that differs from a corresponding portion of the predetermined region. The mobile platform then stores in its memory, a value indicative of a location of the any portion relative to the area. The stored value may be used in any application running in the mobile platform.

### CROSS-REFERENCE TO PROVISIONAL APPLICATION

This application claims priority under 35 USC §119 (e) from U.S. Provisional Application No. 61/511,002 filed on Jul. 22, 2011 and entitled “VIRTUAL SLIDERS: Specifying Values by Occluding a Pattern on a Target”, which is assigned to the assignee hereof and which is incorporated herein by reference in its entirety.

### BACKGROUND

In augmented reality (AR) applications, a real world object is imaged and displayed on a screen along with computer generated information, such as an image or textual information. AR can be used to provide information, either graphical or textual, about a real world object, such as a building or product.

In vision based Augmented Reality (AR) systems, the position of a camera relative to an object in the real world (called target) is tracked, and a processing unit overlays content on top of an image of the object displayed on a screen. Tangible interaction can be used to allow a user to manipulate the object in the real world with the result of manipulation changing the overlaid content on the screen, and in this way allow the user to interact with the mixed reality world.

During such an interaction, the user is partially occluding parts of the scene in the real world from the camera, and also occluding the target used by the camera for tracking. The occlusion of the target as seen by a camera may be detected for use in so called virtual buttons. Whenever an object region's that displayed as a virtual button on the screen happens to be covered by a user's finger, detection of the occlusion triggers an event in the processing unit. While virtual buttons are a powerful tool for user input to the processing unit, the ability of a user to specify a value within a given range is limited and non-intuitive. Thus, what is needed is an improved way to identify a location of an occlusion on a target as described below.

### SUMMARY

A mobile platform captures a scene that includes a real world object, wherein the real world object has a non-uniform pattern in a predetermined region. The mobile platform determines an area in an image of the real world object in the scene corresponding to the predetermined region. The mobile platform compares intensity differences between pairs of pixels in the area, with known intensity differences between pairs of pixels in the non-uniform pattern, to identify any portion of the area that differs from a corresponding portion of the predetermined region. The mobile platform then stores in its memory, a value indicative of a location of the any portion relative to the area. The stored value may be used in any application running in the mobile platform.

### BRIEF DESCRIPTION OF THE DRAWING

FIG. 1A illustrates an object 101 in the real world (also called “real world object”) having a pattern that is non-uniform (e.g. formed of pixels that have different intensities) in a predetermined region 102 for use as a virtual slider in certain embodiments.

FIG. 1B illustrates, in a perspective view, a camera 100 used to image the real world object 101 of FIG. 1A in several embodiments.

FIG. 1C illustrates a portion of the predetermined region 102 being occluded by use of a human finger 112, within a field of view 111 of camera 100 of FIG. 1B in certain embodiments.

FIG. 1D illustrates an image 113 captured by the camera 100 of FIG. 1B in some embodiments.

FIG. 1E illustrates multiple embodiments that compare intensity differences between a pair of pixels 103A, 103B in an area 103 of image 113 corresponding to the predetermined region with corresponding intensity differences between another pair of pixels 104A, 104B in a pattern 104 in an electronic memory 119.

FIG. 1F illustrates a value in a storage element 115 that is generated by some embodiments of a processor 114 based on location of occlusion region 105 at a distance Δx1 relative to a left boundary 103L (also called left end) of area 103.

FIG. 1G illustrates another image 116 captured by the camera 100 of FIG. 1B after the finger 112 has been moved on the real world object 101 (relative to the location shown in FIG. 1D).

FIG. 1H illustrates another value in the storage element 115 generated processor 114 based movement of occluded region 105 to another distance Δx2 relative to the left boundary 102L (also called left end 102L).

FIG. 1I illustrates yet another image 117 captured by the camera 100 of FIG. 1B after translation motion between the camera and the real world object 101 but without relative motion between the real world object 101 and finger 112.

FIGS. 1J and 1L illustrate the value in the storage element 115 being kept unchanged by processor 114 despite images 117 and 118 (see FIG. 1K) being different from image 116.

FIG. 1K illustrates still another image 118 captured by the camera 100 of FIG. 1B after the real world object 101 has been moved closer to the camera still without relative motion between the real world object 101 and finger 112.

FIG. 2 illustrates, in a flow chart, acts performed by processor 114 to generate the values in storage element 115 in some aspects of the described embodiments.

FIG. 3 illustrates, in a block diagram, a mobile platform including processor 114 coupled to an electronic memory 119 of the type described above, in some aspects of the described embodiments.

FIG. 4 illustrates multiple rows of sampling areas in electronic memory 119 used to compare intensity differences in some of the described embodiments.

FIGS. 5A and 5B illustrate, in perspective views, horizontal movement of a user's finger 112 on a pattern 102H imprinted on a pad 501 to cause corresponding horizontal scrolling of text displayed on screen 502 by mobile device 500, in several embodiments.

### DETAILED DESCRIPTION

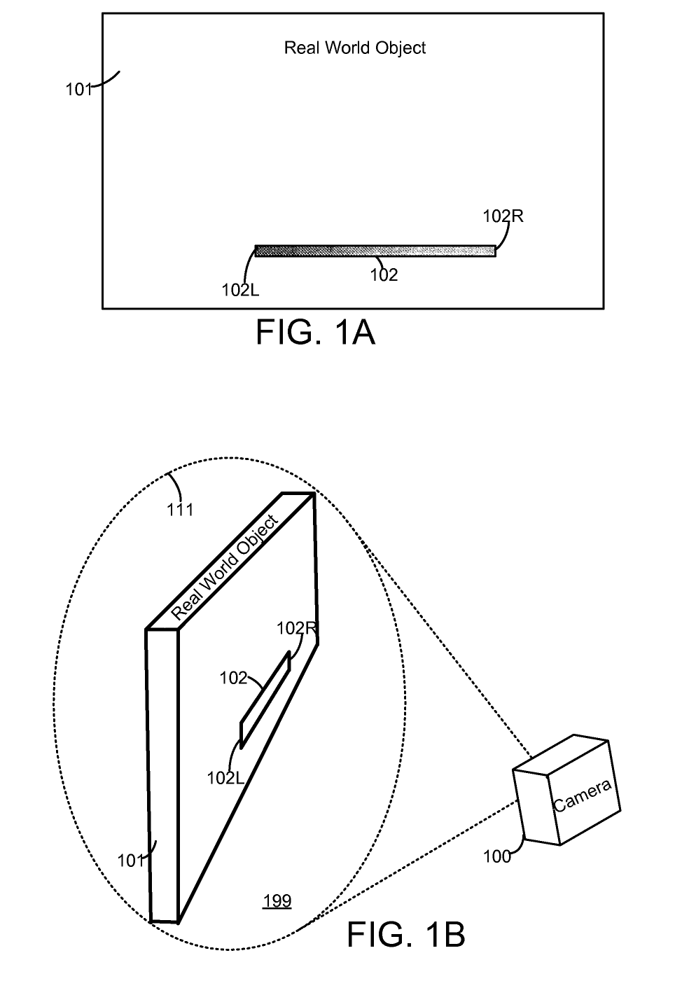

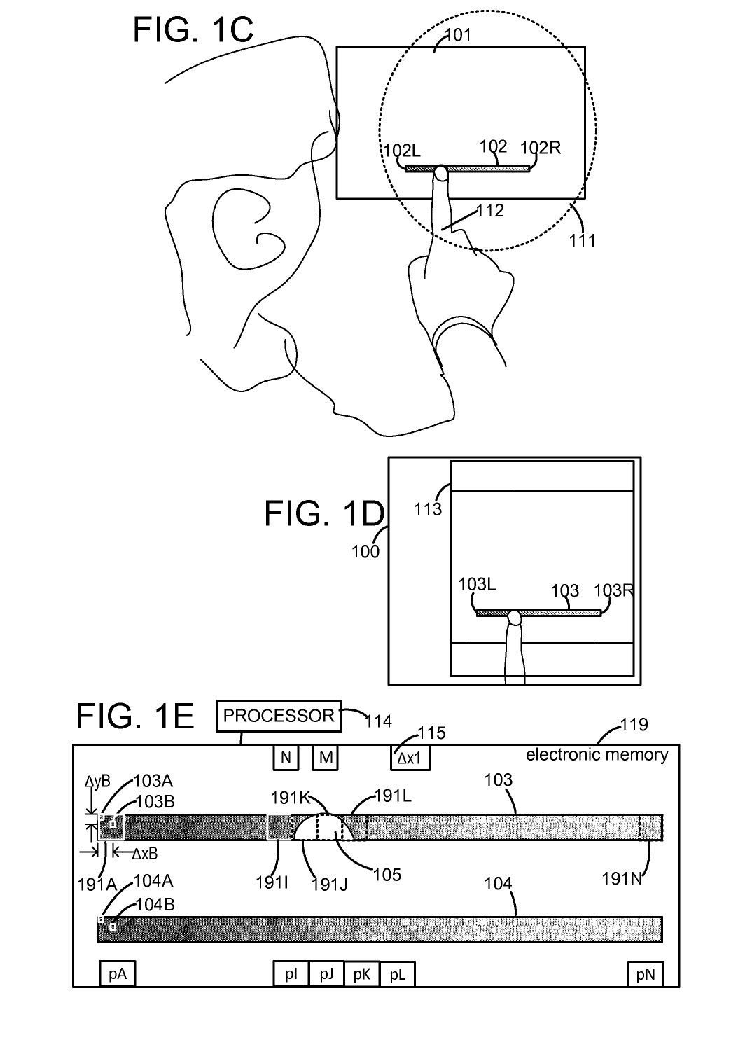

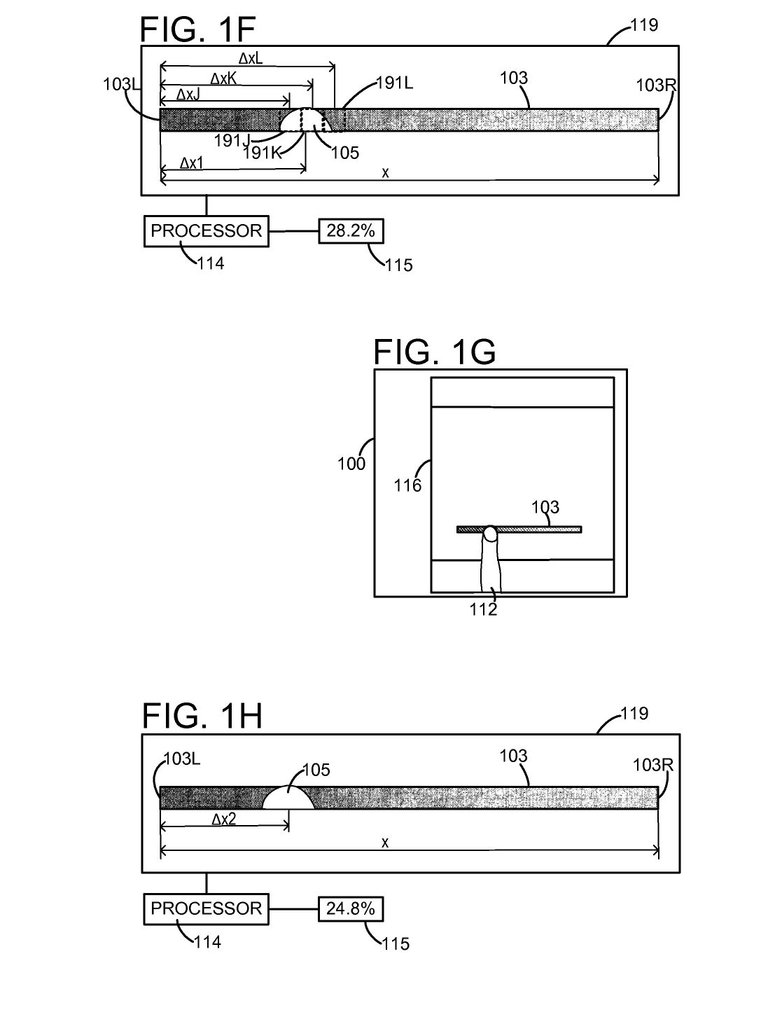

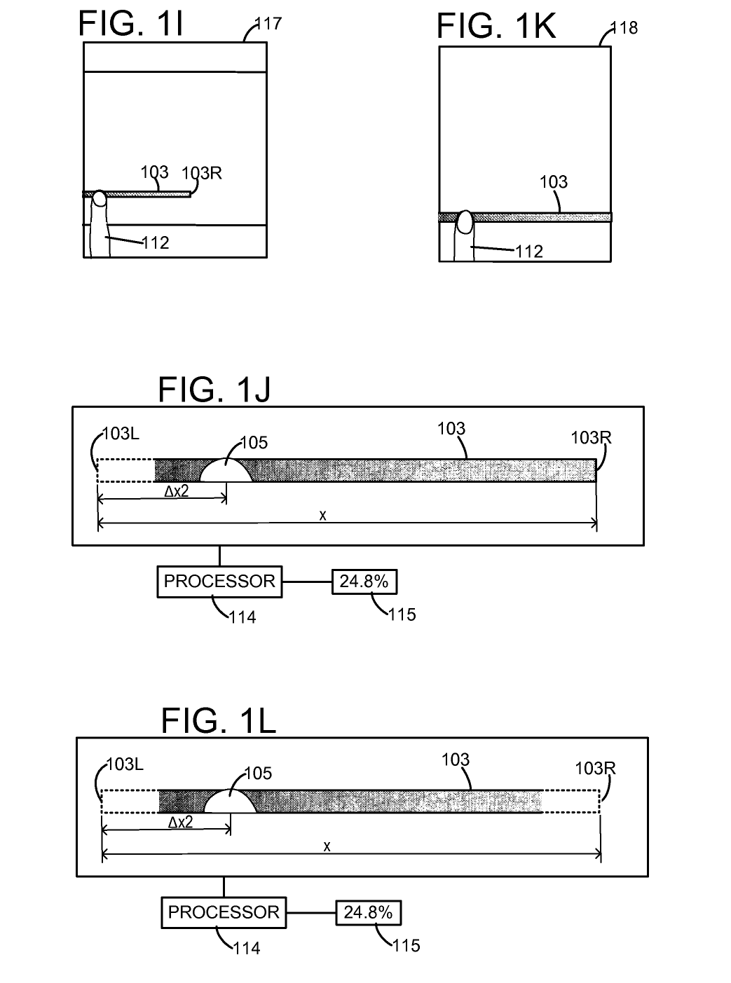

In accordance with the described embodiments, a real world object 101 shown in FIG. 1A (such as a business card) is imprinted with a pattern 102 in a predetermined region, either in different colors and/or grey scales and/or texturized. Pattern 102 is deliberately selected to be not uniform across the predetermined region, e.g. to include binary features for use in tracking that predetermined region across multiple frames of a video captured by a camera 100 (FIG. 1B). The predetermined region (in which pattern 102 is formed) can span different sizes and shapes, although in some aspects of the described embodiments, the region is longitudinal in shape, with two ends, namely a left end 102L (also called left boundary 102L) and a right end 102R (also called right boundary 102R). The predetermined region is made slim in some embodiments so that it can be covered by a finger and the finger can be moved in one direction over the region. Note that in some alternative embodiments, the predetermined region is annular in shape (and the user moves their finger in an arc). Moreover, the predetermined region is shown horizontal in FIG. 1A for convenience of illustration and description herein, although the predetermined region can be vertical or any other orientation relative to object 101.

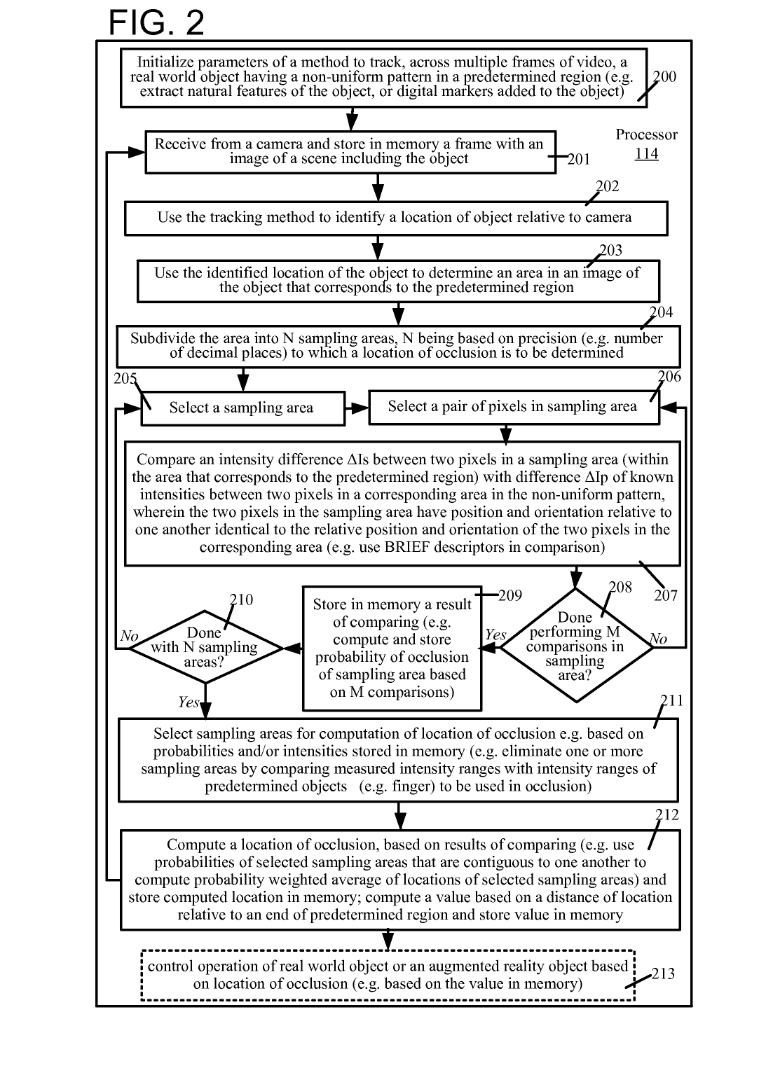

A processor 114 is programmed with software to identify the location of an occlusion from a camera 100 (i.e. hidden from view of the camera) of a region of pattern 102 that is formed on the above-described real world object 101. Specifically, in act 200 (FIG. 2), processor 114 initializes and stores in memory 119 one or more parameters to be used in identifying the just-described location of occlusion. One such parameter that is initialized and stored in memory 119 in act 200 is hereinafter referred to as N. The parameter N is computed based on a precision to which the location is to be determined, of an occlusion of pattern 102 from camera 100. For example, if the distance between the two ends 102L and 102R (FIG. 1A) is 10 cm on real world object 101, and if the occlusion's location is to be determined to a precision of 1 cm within pattern 102, then parameter N is computed as 10/1=10. As another example, when the distance is 20 cm and if the occlusion's location is to be determined to a precision of 0.5 cm, then N is computed as 20/0.5=40. This parameter N is to be used in an act 204, as described below.

In some embodiments, pattern 102 is designed to be sufficiently non-uniform in intensity between the two ends 102L and 102R, so as to be able to identify a location of an occlusion therein, up to a resolution of 1/N. For example, pattern 102 may be formed of pixels that have a predetermined maximum intensity at one end 102L and having a predetermined minimum intensity at the other end 102R, and pixels with intensities that change between the two ends, as shown in FIG. 1A. Depending on the embodiment, each pixel may be sized to be fraction of the size of an area that itself is sized to the resolution 1/N in pattern 102. For example if an area is a square of 0.5 cm×0.5 cm, each pixel in this area may be predetermined to be of size 0.1 cm×0.1 cm and so there are a total of 25 pixels in such an area. In several such embodiments, to detect an occlusion of pattern 102, a predetermined image of pattern 102 is compared with a newly captured image of pattern 102 received from camera 100 by use of differences in intensities of pairs of pixels at predetermined orientations relative to one another.

Depending on the embodiment, two pixels in each pair (described above) in an area may or may not be adjacent to one another. In many embodiments, the intensities of the two pixels in each pair in an area are different from one another, and the differences are described in a descriptor, e.g. by a bit in a binary string. In some embodiments, a number N of areas in a newly captured image are classified, based on results of pair-wise intensity comparisons of pixels at predetermined orientations to identify a match or no match. Multiple results of comparisons in an area are combined and used in determining whether the area is a part of an occlusion. Such comparisons may be performed by use of binary robust independent elementary features (BRIEF) descriptors, as described below. Other descriptors of pixel intensities or differences in pixel intensities in an area of object 101 imprinted with pattern 102 may be used to detect an occlusion of the area, depending on the embodiment.

Various other parameters that are initialized in act 200 depend on a specific tracking method that is implemented in the software to track real world object 101 across multiple frames of video. For example, if natural feature tracking is used in the software, processor 114 initializes in act 200, the parameters that are normally used to track one or more natural features of the real world object 101. As another example, one or more digital markers (not shown) may be imprinted on object 101 and if so one or more parameters normally used to track the digital marker(s) are initialized in act 200. Other such parameter initializations may also be performed in act 200, as will be readily apparent to the skilled artisan in view of the following description.

In accordance with the described embodiments, a camera 100 may be used to image a scene within its field of view 111 (FIG. 1C) so as to generate an image 113 (FIG. 1D) in its local memory. Camera 100 is coupled (either directly or indirectly) to a processor 114 (FIG. 1E), to supply image 113 for processing. Hence, image 113 is received, as per act 201 in FIG. 2, by processor 114 (FIG. 1F) and stored in an electronic memory 119 (e.g. a non-transitory computer-readable storage medium, such as a random-access-memory). Next, as per act 202 in FIG. 2, using the received image 113 with a tracking method (of the type described in the previous paragraph), processor 114 identifies object 101 in the real world (e.g. by pattern recognition, based on a library of images of certain objects) to be a known object, and further identifies a position (e.g. x, y and z coordinates) in the real world of object 101 relative to camera 100.

Next, as per act 203 (FIG. 2), processor 114 uses the position and the object to determine an area 103 in image 113 that corresponds to a predetermined region which is known to contain the predetermined pattern 102. In several embodiments, at this stage, an original target image of pattern 102 (FIG. 1B) is known, and its location on object 101 relative to camera 100 is also known, and hence large differences in color space are used to identify an occluded region in pattern 102.

In some embodiments, as per act 204, processor 114 subdivides the area 103 (FIG. 1D) of image 113 into N sampling areas 191A-191N (wherein A≦I≦N; see FIG. 1E) that are contiguous and located between the two ends 103L and 103R of area 103 (see FIG. 1D). Note that although a single row is shown in FIGS. 1E and 1F, as noted below, multiple rows are used in some embodiments. Moreover, note that N was computed in act 200 as noted above denotes the number of columns in one or more rows, and therefore N is now retrieved from memory 119 and used to perform the subdivision in act 204.

Subsequently, in act 205 (FIG. 2), processor 114 selects a sampling area (e.g. sampling area 191 shown in FIG. 1E) from among N sampling areas 191A-191N and goes to act 206. In act 206, processor 114 selects a pair of pixels in the selected sampling area 191A. The two pixels that are selected in act 206 can be random (or alternatively predetermined), e.g. pixels 103A and 103B may be selected in act 205.

Thereafter, in act 207, processor 114 compares an intensity difference ΔIs between pixels 103A and 103B in image area 103 with a corresponding difference ΔIp between a pair of pixels in the non-uniform pattern that is back projected to the camera plane based on the real world position of object 101. Hence, in some embodiments, processor 114 determines a location of occlusion of a predetermined pattern, based on results of either comparing intensities or comparing intensity differences, because both intensities and intensity differences in areas that are occluded on pattern 102 on real world object 101 do not match corresponding intensities and intensity differences when the areas are not occluded.

For example, as shown in FIG. 1E, intensity at pixel 103A is subtracted from the intensity at pixel 103B to obtain ΔIs. Thereafter, the relative arrangement and/or orientation of pixels 103A and 103B relative to one another e.g. being located Δx away along the x-axis and Δy away along the y-axis is used to identify a corresponding pair of pixels 104A and 104B of an original pattern 104 used to create pattern 102 on real world object 101. Then the intensity at pixel 104A is subtracted from the intensity at pixel 104B to obtain ΔIp. Then the two intensity differences ΔIs and ΔIp are compared to one another. For example, a difference D=ΔIs−ΔIp may be computed in act 207. Alternatively a ratio R=ΔIs/ΔIp may be computed. The specific manner in which the differences ΔIs and ΔIp are compared to one another is different depending on the aspect of the embodiment.

Specifically, in some illustrative aspects of the described embodiments of act 207, processor 114 uses descriptors of intensities of pixels in pattern 102, of the type described in an article entitled “BRIEF: Binary Robust Independent Elementary Features” by Michael Calonder, Vincent Lepetit, Christoph Strecha, and Pascal Fua, published as Lecture Notes In Computer Science at the website obtained by replacing “%” with “I” and replacing “+” with “.” in the following string “http:%% cvlab+epfl+ch %˜calonder % CalonderLSF10+pdf”. The just-described article is incorporated by reference herein in its entirety. Use of descriptors of differences in intensities of pixels in pattern 102 (such as binary robust independent elementary features descriptors or “BRIEF” descriptors) enables comparison of images of pattern 102 (as per act 207) across different poses, lighting conditions etc. Alternative embodiments may use other descriptors of intensities or other descriptors of intensity differences of a type that will be readily apparent in view of this detailed description.

In some embodiments, processor 114 is programmed to smooth the image before comparing pixel intensities or intensity differences of pairs of pixels. Moreover, in such embodiments, processor 114 is programmed to use binary strings as BRIEF descriptors, wherein each bit in a binary string is a result of comparison of two pixels in an area of pattern 102. Specifically, in these embodiments each area in pattern 102 is represented by, for example, a 16-bit (or 32-bit) binary string, which holds the results of 16 comparisons (or 32 comparisons) in the area. When a result of a comparison indicates that a first pixel is of higher intensity than a second pixel, then the corresponding bit is set to 1 else that bit is set to 0. In this example, 16 pairs of pixels (or 32 pairs of pixels) are chosen in each area, and the pixels are selected in a predetermined manner, e.g. to form a Gaussian distribution at a center of the area.

In some aspects of the described embodiments, descriptors of areas in pattern 102 that is to be occluded during use as a virtual slider as described herein are pre-calculated (e.g. based on real world position of object 101 and its pose that is expected during normal use) and stored in memory by processor 114 to enable fast comparison (relative to calculation during each comparison in act 204). Moreover, in several embodiments, similarity between a descriptor of an area in a newly captured image and a descriptor of a corresponding area in pattern 102 is evaluated by computing a Hamming distance between two binary strings (that constitute the two descriptors), to determine whether the binary strings match one another or not. In some embodiments, such descriptors are compared by performance of a bitwise XOR operation on the two binary strings, followed by a bit count operation on the result of the XOR operation. Alternative embodiments use other methods to compare a descriptor of a pattern 102 to a descriptor of an area in the newly-generated image, as will be readily apparent in view of this detailed description.

Next, in act 208, processor 114 checks if M comparisons have been performed in the selected sampling area or pixels 103A. If the answer is no, then processor 114 returns to act 206 to select another pair of pixels. If the answer is yes, then processor 114 goes to act 209, described below. In some aspects of the described embodiments, the number M is predetermined and identical for each sampling area 191I. For example, the number M can be predetermined to be 4 for all sampling areas 191A-191I, in which case four comparisons are performed (by repeating act 207 four times) in each selected sampling area 191I. In other examples, M may be randomly selected within a range and still be identical for each selected sampling area 191I. In still other examples, M may be randomly selected for each sampling area 191I.

In act 209, processor 114 stores in memory 119 one or more results based on the comparison performed in 207. For example, M values of the above-described ratio R or the difference D may be stored to memory 119, one value for each pair of pixels that was compared in act 207, for each sampling area 191I. As another example, the ratio R or the difference D may be averaged across all M pixel pairs in a selected sampling area 191A, and the average may be stored to memory 119.

In one illustrative embodiment, processor 114 computes a probability pA of occlusion of each sampling area 103I, based on the M results of comparison for that sampling area 103I as follows. If a difference D (or ratio R) for a pixel pair is greater than a predetermined threshold, then the binary value 1 is used as follows for that pixel pair and alternatively the binary value 0 is used as follows: the just-described binary values are added up for all the M pixel pairs in sampling area 103I and divided by M to obtain a probability pI. The probability pI that is computed is then stored to memory 119 (FIG. 1E) in act 209. Next, in act 210, processor 114 checks if all N sampling areas have been processed, and if not, returns to act 205 (described above) to select another sampling area, such as area 191I.

When comparison results (e.g. probabilities pA . . . pI . . . pN) have been calculated for all sampling areas 191A, 191I, 191N, processor 114 goes to act 211 to select one or more sampling areas for use in computation of location of an occlusion of pattern 102 in image area 103. The specific manner in which sampling areas are selected in act 211 for occlusion location computation can be different, depending on the aspect of the described embodiments. For example, some embodiments compare intensities of pixels in a newly captured image with corresponding intensity ranges of another real world object (also called “occluding object”) predetermined for use in forming an occlusion of pattern 102 on object 101, such as a human finger 112 (FIG. 1C) or a pencil, and conclude that the occlusion is present when there is a match.

In the case of a human finger 112, certain embodiments compare known intensity ranges of human skin to determine whether or not to filter out (i.e. eliminate) one or more sampling areas when selecting sampling areas in act 211, for computation of location of an occlusion. Similarly, a total width of a group of contiguous sampling areas may be compared to a predetermined limit which is selected ahead of time, based on the size of an adult human's finger to filter out sampling areas. Depending on the embodiment, known intensities of human skin that are used in act 211 as described herein are predetermined, e.g. by requiring a user to provide sample images of their fingers, during initialization. Hence in such embodiments, two sets of known intensities are compared, e.g. one set of pattern 102 in act 207 and another set of human finger 112 in act 211. Other embodiments may select sampling areas (thereby to eliminate unselected areas) in act 211 based on BRIEF descriptors that are found to not match any BRIEF descriptors of pattern 102, by use of predetermined criteria in such matching, thereby to use just a single set of known intensities (of pattern 102).

Next, as per act 212, processor 114 uses probabilities of sampling areas that were selected in act 211 and are contiguous to one another to compute a location of occlusion 105 relative to image area 103. For example, by use of such areas, an occlusion's location may be computed as being Δx1 away from a left edge 103L (FIG. 1F) corresponding to a left edge 102L (FIG. 1C) of pattern 102 on real world object 101. Note that the specific manner in which Δx1 is computed from the probabilities of the selected sampling areas can be different, depending on the aspect of the described embodiment. Moreover, other embodiments use sampling areas that were selected in act 211 without using any probabilities to determine an occlusion's location, e.g. by averaging x-axis locations of selected areas that are determined to be contiguous with one another (while eliminating any non-contiguous areas). Therefore, to summarize act 212, processor 114 computes a location of occlusion 105, based on results of comparing the intensity differences in act 207 (described above).

In one illustrative embodiment of act 212, processor 114 computes a probability weighted average of the locations of the selected sampling areas, as follows. For example, sampling areas 191J, 191K and 191L (see FIG. 1E) may be selected in act 211 and in act 202, processor 114 uses their respective probabilities pJ, pK and pL (see FIG. 1E) with their respective locations ΔxJ, ΔxK, ΔxL (see FIG. 1F) to compute Δx1 as the following weighted average pJ*ΔxJ+pK*ΔxK+pL*ΔxL. Note that in the specific example illustrated in FIG. 1E, the probability pK is higher than the probability pJ and the probability pJ in turn is higher than the probability pL and therefore the use of these three probabilities in computing the weighted average provides a more precise value for the location Δx1 of occlusion 105 than if a simple average of locations ΔxJ, ΔxK, ΔxL was computed (i.e. without probabilities) and used as location Δx1.

Note that the just-described weighted average as well as the just-described simple average (see previous paragraph) both provide more precision than identification of a single digital marker, from among a sequence of digital markers of the type described in an article entitled “Occlusion based Interaction Methods for Tangible Augmented Reality Environments” by Lee, G. A. et al published in the Proceedings of the 2004 ACM SIGGRAPH International Conference on Virtual Reality Continuum and Its Applications in Industry (VRCAI '04), pp. 419-426 that is incorporated by reference herein in its entirety.

Note that in some embodiments of the type described herein, although markers are used to identify the location of an object in an image and/or location of an area that corresponds to the predetermined region (as per act 203), the markers are not used to compute the location of occlusion in act 212. Instead, in several embodiments of the type described herein, an occlusion's location is computed in act 212 using the results of comparing two intensity differences, namely a first intensity difference between two pixels within the identified area that corresponds to the predetermined region, and a second intensity difference between two pixels within the non-uniform pattern that correspond to the two pixels used to compute the first intensity difference. As noted above, in many such embodiments, two pixels used in the second intensity difference have locations that differ from each other (e.g. by Δx, Δy) identical to corresponding difference in locations of the two pixels used in the first intensity difference.

Referring back to FIG. 2, at the end of act 212, processor 114 stores the occlusion's identified location Δx1 in a storage element 115 in memory 119 (see FIG. 1E). In some aspects of the described embodiments, the location Δx1 is scaled relative to the total length x of area 103 (i.e. distance between left edge 103L and right edge 103R), i.e. the value stored in storage element 115 by processor 114 is Δx1/x expressed as a percentage, e.g. 28.2% (see FIG. 1F). On movement of the occlusion 105 due to movement of finger 112 (FIG. 1G), the percentage is updated e.g. 24.8% (see FIG. 1H). In other embodiments, the value is expressed as a two-digit fraction between 0 and 1, in this example the value 0.28 is stored in memory 119. Either the value or the location or both may be stored in memory 119, depending on the embodiment. The value in storage element 115 constitutes a user input in some embodiments, which is used (e.g. by processor 114) in a manner that is identical or similar to user input from a slider control displayed on a touch screen.

Next, processor 114 returns to act 201 (described above) and repeats the just-described acts, to update the value in storage element 115 based on changes in location of occlusion 105 relative to image area 103, e.g. when the user moves finger 112 across region 102 on real world object 101 (FIG. 1C). Therefore, the value in storage element 115 can change continuously (or change periodically, at a preset time interval, e.g. once every second) in response to movement of finger 112. Hence, this value is used by processor 114 as a continuous user input from a virtual slider, in any software and/or hardware in any apparatus or electronic device, in a manner similar or identical to any real world slider (such as a slider in a dashboard of an automobile used to control flow of hot and/or cold air within the passenger compartment of the automobile).

Use of descriptors of intensity differences (e.g. BRIEF descriptors) by processor 114 in comparison in act 207 in combination with use of a tracking method in act 202 enables a location of an occlusion to be identified precisely, relative to an end (e.g. end 102L) of a predetermined area (wherein the pattern 102 is included) on a real world object 101 (also called “target”). Specifically, use of natural features and/or digital markers on real world object 101 with appropriate programming of processor 114 can track object 101 even after a portion of pattern 102 goes out of the field of view 111 of camera 100. For example, translation between camera 100 and object 101 may cause left edge 103L to disappear from the field of view 111 and therefore absent from an image 117 (FIG. 1I) and or object 101 may be brought closer to camera 100 resulting in both edges 103L and 103R disappearing from another image 118 (FIG. 1K). Despite disappearances, FIGS. 1J and 1L illustrate that the value in storage element 115 can be kept unchanged by processor 114, by continuing to track object 101 as described.

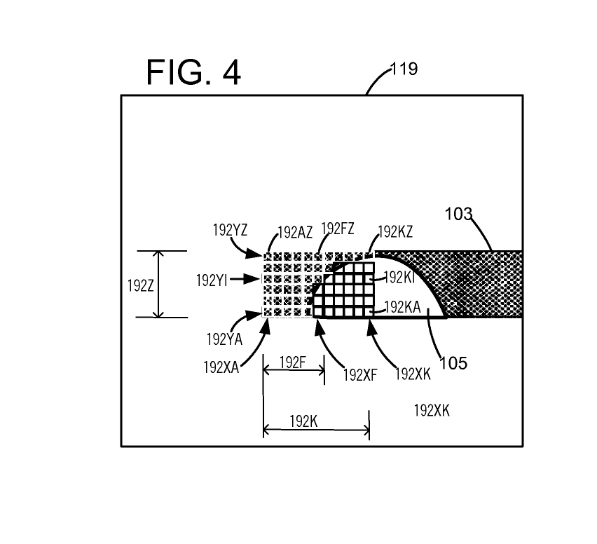

Although a single row of sampling areas 191A-191N have been illustrated in FIGS. 1E and 1F in the above description in reference to acts 204-212, as will be readily apparent in view of this disclosure, multiple rows of sampling areas may be used in some of the described embodiments. Specifically, FIG. 4 illustrates multiple rows 192YA . . . 192YI . . . 192YZ, and each row includes a number of sampling areas. For example, row 192YZ includes sampling areas 192AZ . . . 192FZ . . . 192KZ. Note that each sampling area in a row also belongs to a column, e.g. sampling area 192AZ belongs to column 192XA, sampling area 192FZ belongs to column 192XF, and sampling area 192KZ belongs to column 192XK.

In such embodiments, in act 204, the area 103 may be subdivided into a two-dimensional array of sampling areas. In the example illustrated in FIG. 4, a left-most square portion of area 103 spanning the distance 192F in the horizontal direction and the distance 192Z in the vertical direction is shown subdivided into 36 sampling areas, located in the six rows 192YA-1927Z and the six columns 192XA-192XF. In such an example, if it is desired to have 100 sampling areas in a 5 cm×5 cm square portion of area 103, processor 114 may be programmed to perform act 103 by subdividing such a square portion into 20 sample areas per cm in x-direction and also 20 sample areas per cm in y-direction. So if a pattern 102 (FIGS. 1A, 1B) for the slider has a height of 1 cm there may be 20 rows of the type shown in FIG. 4.

In such embodiments, acts 204-212 are performed by processor 114 being appropriately programmed to use the multiple rows of sampling areas in such a two-dimensional array that is formed in electronic memory 119. For example, in computing an occlusion's location, a weighted average of probabilities of sampling areas 192KA . . . 192KI . . . 192KZ (FIG. 4) may be used to obtain a single probability for a column 192XK which may then be used in the above-described manner, specifically as a probability at location 192K (similar to the probability of a sampling area in a single row as described above in reference to FIGS. 1E and 1F). As another example, the probability of each sampling area 192KA . . . 192KI . . . 192KZ may be compared with a pre-set threshold and a binary value obtained for each sampling area, and such binary values of sampling areas in a column are used to compute a single probability for column 192XK (e.g. the binary values may be added up, and the resulting sum divided by the number of rows), and that single probability may then be used as the probability of occlusion at location 192K, in the manner described above for a single row (in reference to FIGS. 1E and 1F).

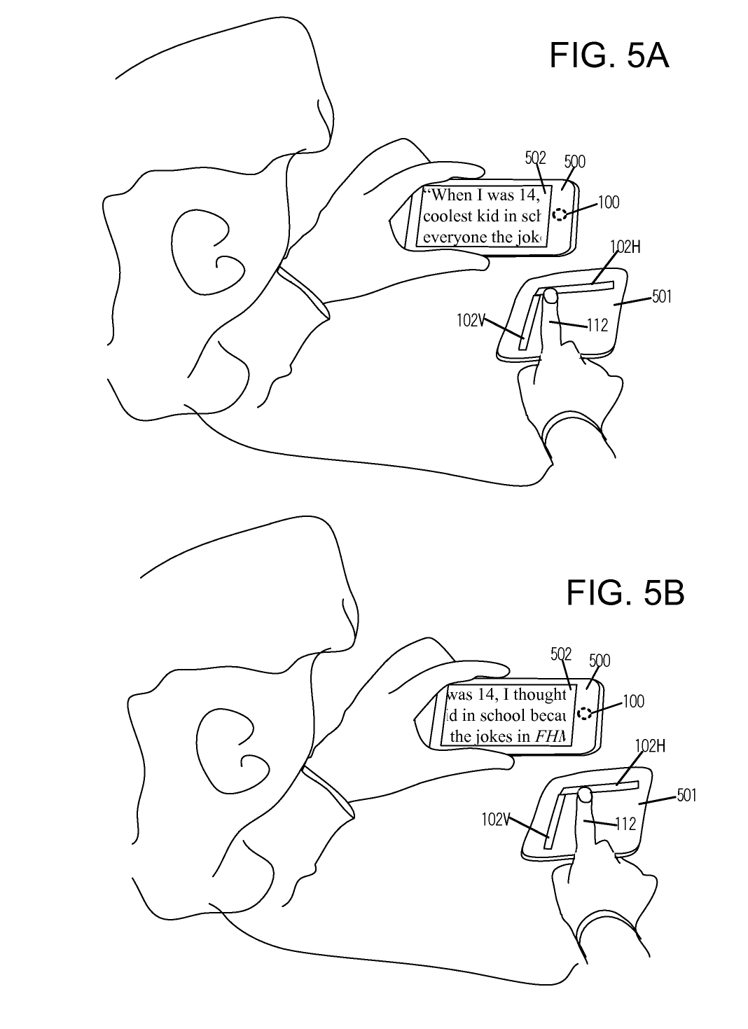

A value in storage element 115 can be used as an output of a slider control i.e. as a virtual slider. Hence, such a value can control (as per act 213 in FIG. 2) the operation of, for example, the above-described real world object 101 that carries pattern 102 (e.g. in embodiments wherein object 101 is a toy) by generation of a signal to the object. Instead of controlling object 101, the signal based on the value in storage element 115 can control operation of another real world object (e.g. a thermostat to increase or decrease temperature of a room). As another example, use of such a virtual slider can control operation of an augmented reality (AR) object in a mobile platform that includes processor 114 and camera 100. As still another example, use of the virtual slider can control scrolling of text that is displayed on a mobile platform as described below in reference to FIGS. 5A and 5B.

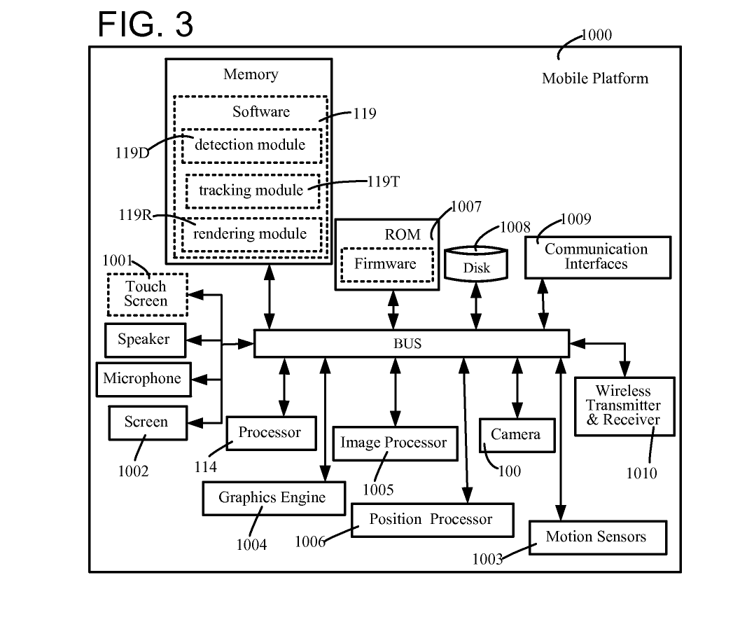

Thus output of a virtual slider, formed by user input via storage element 115 as described herein can be used similar to user input from physically touching a real world slider on a touch screen of a mobile device. However, note that pattern 102 is located directly on the real world object 101 (also called “target”), so that the user can directly work with object 101 without putting their finger 112 back to a touch screen 1001 of a mobile platform 1000 (FIG. 3). Moreover, a virtual slider in several aspects of the described embodiments, uses a pattern 102 imprinted or embossed only at a border of real world object 101, so as to avoid occluding other parts of object 101 from being viewed in touch screen 1001 of mobile platform 1000.

Several embodiments of the type described herein are implemented by processor 114 included in mobile platform 1000 (FIG. 3) that is capable of rendering augmented reality (AR) graphics as an indication of regions of the image with which the user may interact. In AR applications, specific “regions of interest” can be defined on the image of a physical object, which when selected by the user can generate an event that the mobile platform may use to take a specific action. Such a mobile platform 1000 (FIG. 3) may include a screen 1002 that is not touch sensitive (instead of touch screen 1001), because user input is provided via storage element 115 that may be included in memory 119 of mobile platform 1000. The mobile platform 1000 may also include a camera 100 of the type described above to generate frames of a video of real world object 101. The mobile platform 1000 may further include motion sensors 1003, such as accelerometers, gyroscopes or the like, which may be used to assist in determining the pose of the mobile platform 1000 relative to real world object 101. Also, mobile platform 1000 may additionally include a graphics engine 1004, an image processor 1005, a position processor 1006. Position processor 1006 is programmed in some embodiments with instructions (also called “position module”) that enable mobile platform 1000 to determine a position of object 101 in the real world, e.g. relative to camera 100. Mobile platform 1000 may also include a disk 1008 to store data and/or software for use by processor 114. Mobile platform 1000 may further include a wireless transceiver 1010 and/or any other communication interfaces 1009. It should be understood that mobile platform 1000 may be any portable electronic device such as a cellular phone or other wireless communication device, personal communication system (PCS) device, personal navigation device (PND), Personal Information Manager (PIM), Personal Digital Assistant (PDA), laptop, camera, iPad, or other suitable apparatus or mobile device that is capable of augmented reality (AR).

In an Augmented Reality environment there might be different interaction metaphors used. Tangible interaction allows a user to reach into the scene and manipulate objects directly (as opposed to embodied interaction, where users do interaction direct on the device). Use of a virtual slider as described herein eliminates the need to switch between two metaphors, thereby to eliminate any user confusion arising from switching. Specifically, when tangible interaction is chosen as an input technique, virtual sliders (together with virtual buttons) allow a user to use his hands in the real world with his attention focused in the virtual 3D world, even when the user needs to scroll to input a continuously changing value.

Virtual sliders as described herein can have a broad range of usage patterns. Specifically, virtual sliders can be used in many cases and applications similar to real world sliders on touch screens. Moreover, virtual sliders can be used in an AR setting even when there is no touch screen available on mobile phones. Also, use of virtual sliders allows a user to select between different tools very easily and also to use the UI of the interaction device to specify specific tool parameters. This leads to much faster manipulation times. Virtual sliders as described herein cover a broad range of activities, so it is possible to use virtual sliders as the only interaction technique for a whole application (or even for many different applications). This means once a user has learned to use virtual sliders, he will not need to learn any other tool.

A mobile platform 1000 of the type described above may include functions to perform various position determination methods, and other functions, such as object recognition using “computer vision” techniques. The mobile platform 1000 may also include circuitry for controlling real world object 101 in response to user input via occlusion detected and stored in storage element 115, such as transmitter in transceiver 1010, which may be an IR or RF transmitter or a wireless a transmitter enabled to transmit one or more signals over one or more types of wireless communication networks such as the Internet, WiFi, cellular wireless network or other network. The mobile platform 1000 may further include, in a user interface, a microphone and a speaker (not labeled) in addition to touch screen 1001 and/or screen 1002 which is not touch sensitive, used for displaying captured scenes and rendered AR objects. Of course, mobile platform 1000 may include other elements unrelated to the present disclosure, such as a read-only-memory 1007 which may be used to store firmware for use by processor 114.

Although the embodiments described herein are illustrated for instructional purposes, various embodiments not limited thereto. For example, although item 1000 shown in FIG. 3 of some embodiments is a mobile device, in other embodiments 1000 is implemented by use of one or more parts that are stationary relative to a scene 199 (FIG. 1B) whose image is being captured by camera 100 and in such embodiments camera 100 is itself stationary and processor 114 and memory 119 are portions of a computer, such as a desk-top computer or a server computer.

Memory 119 of several embodiments of the type described above includes software instructions for a detection module 119D that are also executed by one or more processors 114 to detect presence of human finger 112 overlaid on pattern 102 of real world object 101. Depending on the embodiment, such software instructions (e.g. to perform the method of FIG. 2) are stored in a non-transitory, non-volatile memory of mobile platform 1000, such as a hard disk or a static random access memory (SRAM), and optionally on an external computer (not shown) accessible wirelessly by mobile platform 1000 (e.g. via a cell phone network).

In addition to module 119D described in the preceding paragraph, memory 119 of several embodiments also includes software instructions of a tracking module 119T that are also executed by one or more processors 114, to track movement over time of a location of occlusion, specifically by presence of finger 112 on pattern 102 of object 101. Such a tracking module 119T is also used by a mobile platform 1000 to track digital marker(s), as described above. In several embodiments, an occlusion's location data output by tracking module 119T (e.g. x coordinate of an occlusion) is used by one or more of processors 114 to control information displayed to a user, by execution of instructions in a rendering module 119R. Hence, instructions in rendering module 119R render different information on screen 1002 (or touch screen 1001), depending on an occlusion's location as determined in detection module 119D and/or tracking module 119T.

In one such example, an embodiment of real world object 101 described above is a pad 501 (FIG. 5A) made of foam (e.g. similar or identical to a mouse pad), that has imprinted thereon two longitudinal patterns 102V and 102H, in the shape of rectangles with length x (i.e. distance between left edge 103L and right edge 103R in FIG. 1J) several times (e.g. 10 times) greater than width (distance 192Z in FIG. 4). Patterns 102V and 102H are oriented perpendicular to one another on pad 501, both starting in a top left corner thereof. Pattern 102H is located adjacent to a top edge of pad 501 whereas pattern 102V is located adjacent to a left edge of pad 501.

In the example shown in FIG. 5A, pattern 102H is used with software modules 119D and 119T as a horizontal virtual slider, by the user moving their finger 112 from left to right, and this horizontal movement is captured in a sequence of images by a rear-facing camera 100 included in a mobile phone or more generally mobile device 500 (which implements mobile platform 1000 of the type described above). The sequence of images are used by detection module 119D and/or tracking module 119T to supply a corresponding sequence of locations of an occlusion to rendering module 119R that in turn scrolls the text horizontally towards the right, as shown in FIG. 5B in this example. Although in the example shown in FIGS. 5A and 5B the movement of an occlusion by moving the user's finger 112 on pattern 102H is used as a virtual slider to scroll text horizontally on screen 502, in a similar manner finger 112 can be used to move an occlusion on pattern 102V, in order to scroll text vertically on screen 502.

Accordingly, pattern 102H (FIGS. 5A, 5B) when occluded as described above forms a slider on pad 501, in a manner similar or identical to a slider displayed on a touch screen 1001 (FIG. 3), but without requiring screen 502 of mobile device 500 to be touch sensitive. Specifically, a user moves their finger 112 directly on object or pad 501 in the real world, instead of putting their finger 112 back on screen 502. Accordingly, a user can use one hand (in FIGS. 5A and 5B, their left hand) to hold mobile device 500, while using another hand (in FIGS. 5A and 5B, their right hand) to manipulate object or pad 501 in the real world. The just-described interaction between a user and a mobile device 500 enables the user to reach into a scene in the real world directly using one hand, while simultaneously visually viewing information displayed on screen 502 held using another hand, resulting in user experiences of an augmented reality world. Moreover, such an interaction technique, based on virtual sliders, can be used in an augmented reality setting even when there is no touch screen available on mobile phones.

Although in some embodiments, the above-described software modules 119D, 119T and 119R are all present in a common memory 119 of a single device 1000, in other embodiments one or more such software modules 119D, 119T and 119R are present in different memories that are in turn included in different electronic devices and/or computers as will be readily apparent in view of this detailed description. Moreover, instead of modules 119D, 119T and 119R being implemented in software, as instructions stored in memory 119, one or more such modules are implemented in hardware logic in other embodiments.

Various adaptations and modifications may be made without departing from the scope of the embodiments. Therefore, the spirit and scope of the appended claims should not be limited to the foregoing description.

What is claimed is:

1. A method comprising:
receiving an image of a scene;
wherein the scene includes a real world object having a non-uniform pattern in a predetermined region;
determining an area in the image that corresponds to the predetermined region;
comparing intensity differences between first pairs of pixels in the area with known intensity differences between second pairs of pixels in the non-uniform pattern;
computing a location of an occlusion in the area of the non-uniform pattern, based on a result of the comparing; and
storing the location in memory.

2. The method of claim 1 wherein:
the area is longitudinal and has two ends;
the location is between the two ends; and
the method further comprises computing a value based on a distance of the location relative to an end of the area, and storing the value in memory.

3. The method of claim 1 further comprising:
controlling an operation of the real world object or another real world object, based on the location.

4. The method of claim 1 wherein the real world object is hereinafter first real world object and wherein:
first intensity differences in a first portion of the area are different from second intensity differences in a second portion in the non-uniform pattern that corresponds to the first portion due to the occlusion of the first real world object by a second real world object.

5. The method of claim 4 wherein multiple portions of the area are identified by the comparing and the method further comprising:
eliminating at least one of the multiple portions by comparing intensities of a first plurality of pixels including the first pairs of pixels in the area with additional known intensities of a second plurality of pixels in the second real world object.

6. The method of claim 4 wherein:
the second real world object is a human finger; and
the method further comprises comparing intensities of a plurality of pixels with intensities of human skin color.

7. The method of claim 1 wherein:
the comparing comprises using binary robust independent elementary features descriptors.

8. The method of claim 1 further comprising:
identifying a position of the real world object in the scene relative to a camera used in the capturing; and
using the position in the determining.

9. A mobile platform comprising:
a camera;
a processor operatively connected to the camera;
memory operatively connected to the processor; and
software held in the memory that when run in the processor causes the camera to capture a scene that includes a real world object having a non-uniform pattern in a predetermined region, causes the processor to determine an area in an image of the real world object in the scene captured by the camera and corresponding to the predetermined region, causes the processor to compare intensity differences between first pairs of pixels in the area with known intensity differences between second pairs of pixels in the non-uniform pattern, causes the processor to compute a location of an occlusion in the area of the non-uniform pattern based on a result of comparison and store the location in the memory.

10. The mobile platform of claim 9 wherein the software that when run in the processor causes the processor to generate a signal to control an operation of the real world object based on the location.

11. The mobile platform of claim 9 wherein the software that when run in the processor causes the processor to generate a signal to control an operation of another real world object based on the location.

12. The mobile platform of claim 9 wherein the real world object is hereinafter first real world object and wherein the any portion differs from a corresponding portion due to the occlusion of the first real world object by a second object.

13. The mobile platform of claim 9 wherein multiple portions of the area are identified by intensity difference comparison by the processor and wherein the software that when run in the processor causes the processor to eliminate at least one of the multiple portions by comparing intensities of a first plurality of pixels including the first pairs of pixels in the area with additional known intensities of a second plurality of pixels in a second real world object.

14. The mobile platform of claim 13 wherein the second real world object is a human finger and wherein the software that when run in the processor causes the processor to compare intensities of the first plurality of pixels with intensities of human skin color.

15. The mobile platform of claim 9 wherein the software that when run in the processor causes the processor to use binary robust independent elementary features descriptors.

16. The mobile platform of claim 9 wherein the software that when run in the processor causes the processor to identify a position of the real world object in the scene relative to the camera and use the position to determine the area.

17. The mobile platform of claim 9 further comprising a screen and instructions that when executed in the processor causes the processor to render information on the screen based at least partially on the location.

18. An apparatus comprising:
means for receiving an image of a scene;
wherein the scene includes a real world object having a non-uniform pattern in a predetermined region;
means for determining an area in the image that corresponds to the predetermined region;
means for comparing intensity differences between first pairs of pixels in the area with known intensity differences between second pairs of pixels in the non-uniform pattern;
means for computing a location of an occlusion in the area of the non-uniform pattern, based on a result of the comparing; and
means for storing the location in memory.

19. The apparatus of claim 18 wherein multiple portions of the area are identified by the means for comparing intensity differences and the apparatus further comprising:
means for eliminating at least one of the multiple portions by comparing intensities of a first plurality of pixels including the first pairs of pixels in the area with additional known intensities of a second plurality of pixels in another real world object.

20. A non-transitory computer-readable storage medium comprising:
first instructions to one or more processors to receive an image of a scene;
wherein the scene includes a real world object having a non-uniform pattern in a predetermined region;
second instructions to the one or more processors to determine an area in the image that corresponds to the predetermined region;
third instructions to the one or more processors to compare intensity differences between first pairs of pixels in the area with known intensity differences between second pairs of pixels in the non-uniform pattern;
fourth instructions to the one or more processors to compute a location of an occlusion in the area of the non-uniform pattern, based on a result of the comparing; and
fifth instructions to the one or more processors storing the location in a memory.

21. The non-transitory computer-readable storage medium of claim 20 wherein multiple portions of the area are identified by execution of the third instructions to the one or more processors to compare and the non-transitory computer-readable storage medium further comprising:
sixth instructions to the one or more processors to eliminate at least one of the multiple portions by comparing intensities of a first plurality of pixels including the first pairs of pixels in the area with additional known intensities of a second plurality of pixels in another real world object.
